(19) United States
(12) Patent Application Publication
(10) Pub. No.: US 2006/0056420 A1
(43) Pub. Date: Mar. 16, 2006

(54) Communication apparatus selecting a source address

(75) Inventors: Masato Okuda, Kawasaki (JP); Naoki Matsuoka, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/034,601

(22) Filed: Jan. 13, 2005

(30) Foreign Application Priority Data
Sep. 16, 2004 (JP) 2004-269383

(51) Int. Cl. H04L 12/56

(52) U.S. Cl. 370/395.54

(57) ABSTRACT

There is provided a communication apparatus connectable with a plurality of networks and is assigned with source addresses to connect with each respective one of the plurality of networks, comprising a communication path characteristics information acquiring unit for acquiring characteristics information of each communication path through each network to a destination, having received information relating to the destination of data to be transmitted; a source address selecting unit for selecting one source address among a plurality of source addresses based on the characteristics information; and a transmitting unit for transmitting the data to be transmitted, to a network corresponding to the selected source address. According to this constitution, the communication apparatus assigned a plurality of source addresses can select a source address corresponding to a network having the optimal communication path among a plurality of networks and communicate using the selected source address.

### BACKGROUND OF THE INVENTION

1. Field of the Invention

The present invention relates to a communication apparatus that selects a source address to enable the communication apparatus to communicate with another communication apparatus through an appropriate communication path in case that the communication apparatus executing a packet communication is connected with a plurality of networks and is assigned an address from each of the networks.

2. Description of the Related Art

In recent years, the Internet based on the IP (Internet Protocol) technology has been rapidly prevailing all over the world. For the Internet, the business entities called network providers or Internet service providers (ISP) assign each user an IP address or a prefix in the higher-order bits of an IP address and the communication apparatus of the user (for example, a personal computer) accesses the Internet using the IP address containing the IP address or the prefix as a source address of the communication apparatus.

Recently, a user tend to be assigned an IP address (or a prefix) respectively from each of a plurality of networks because each of the business entities provides proprietary services thereof or the user accesses networks in companies.

As described above, in case that a plurality of IP addresses are assigned, it is necessary to select one (1) of these IP addresses as a source address and access a network using the selected IP address. As a method of selecting a source address, an organization, IETF (the Internet Engineering Task Force) that conducts a standardization activity of, for example, the specifications of the Internet, etc. has employed the following method as a standard. That is, a conventional source address selection method is a method of selecting a source address based on the longest-prefix-matching of a destination address and a prefix.

FIG. 1 is an illustrative diagram of the conventional source address selection method. In FIG. 1, when a communication apparatus X having a plurality of IP addresses communicates with a destination communication apparatus Y, the communication apparatus X selects an IP address based on the longest-prefix-matching. More specifically, in case that the communication apparatus X has two (2) IP addresses 2001:0:10::1 and 2001:100:10:1 and an IP address of the destination communication apparatus Y is 2001:100:20::1, the communication apparatus X selects the IP address 2001:100:10::1 (an IP address assigned by a network provider B) for which the coincidence degree between the IP addresses of the destination communication apparatus Y and the prefix thereof is higher.

However, two addresses are not always closer to each other in terms of networks as the portion of a prefix that coincides becomes longer. For example, when a fault is present on a path on the way to the destination communication apparatus Y, the communication is impossible. Even when no fault is present and communication with the destination communication apparatus Y can be executed normally, cases where performance such as delay, etc. becomes better when the communication is executed through a network provider A can be considered. Furthermore, when a fault is present on a return path from the destination communication apparatus Y, the communication is impossible. In addition, when an access is made to the Internet using, as the source address, an address for a closed area network for a network service provider business entity to provide proprietary services thereof, a fatal problem arises that no return path exists because of the closed area network having no connection with the Internet.

Furthermore, it has been pointed out that the problem of “Site Exit Issue” is also present. The “Site Exit Issue” is caused by “Ingress Filtering” that is a function for discarding a packet having a source address other than an address/prefix assigned by a provider in order to prevent “address spoofing”. That is, when a packet is routed to a provider other than the provider that has assigned the source address selected by a host, the packet is discarded by the Ingress Filtering and the communication can not be executed at all. IEIF has proposed the following four (4) methods in order to solve this “Site Exit Issue”. However, each of the methods has tasks.

(1) Relaxing of the Rules of the Ingress Filtering

Employing this method, the effect of the Ingress Filtering against the address spoofing is decreased and the weakness of the security is increased.

(2) Source Address Routing

This method has an advantage that a communication apparatus can control paths to some extent. However, that a path is optimal, that the connectability is secured, etc. are not guaranteed.

(3) Source Address Selection by a Terminal (Source Address Discovery (SAD), Exit Router Discovery (ERD))

SAD: Delay is considerable and the path is not always optimal because source addresses are changed one after another until communication becomes possible as in Path MTU-Discovery.

ERD: Setting of a tunnel leading to a Exit Router is necessary and the load on the communication apparatus is increased.

(4) NAT

In case that IPv6 that enables direct end-to-end communication is employed, this advantage is cancelled.

As described above, in the standardizing technology, the optimization of a path (example: RTT is the minimum) and the Site Exit Issue can not be solved simultaneously.

On the other hand, in order to cope with the tasks of the standardizing technology as described above, it has been proposed in Japanese Patent Application Laid-Open Publication No. 2003-298635 that, in a multi-home environment where a plurality of ISPs are connected, communication is enabled by source-address-routing by a router using as a source address an address prefix assigned by an ISP for which connectability has been confirmed. In Japanese Patent Application Laid-Open Publication No. 2003-298635, it is described that the connectability with each of the ISPs is confirmed using an ND (Neighbor Discovery) message for IPv6, etc. as well as executing source-address-routing.

However, according to the present invention described in Japanese Patent Application Laid-Open Publication No. 2003-298625, connectability with a destination domain/host can not be guaranteed because only the connectability with ISPs is confirmed. Furthermore, of which ISP a prefix should be used when connectability with a plurality of ISPs is confirmed is not specified.

On the other hand, according to Japanese Patent Application Laid-Open Publication No. 2003-324461, in an environment where address prefixes are assigned from a plurality of routers, a virtual interface is created for each of the assigned address prefixes and is given addresses created using the address prefixes. Then, source address selection is executed based on the longest-prefix-matching with a destination address. Moreover, it is described that, when the address prefixes are distributed, the packet processing efficiency is improved by distributing labels respectively correlated with each of the prefixes.

However, the source address selection method itself is within the range of the above standardizing technology and tasks still remain in executing communication on the optimal path and solving the Site Exit Issue.

Therefore, it is desired to provide a source address selection method that guarantees the End-to-End connectability and enables communication through a communication path for which the performance becomes optimal as described above.

### SUMMARY OF THE INVENTION

The object of the present invention is therefore to provide a communication apparatus that selects one (1) address from addresses assigned by a plurality of network providers and communicates using the selected address as a source address, wherein bidirectional connectability with a destination communication apparatus is confirmed and a source address for communication through a communication path with higher performance is selected.

In order to achieve the above object, according to the major aspect of the present invention there is provided a communication apparatus that is connectable with a plurality of networks and is assigned with source addresses to connect with each respective one of the plurality of networks, comprising a communication path characteristics information acquiring unit for acquiring characteristics information of each communication path through each network to a destination, having received information relating to the destination of data to be transmitted; a source address selecting unit for selecting one (1) source address among a plurality of source addresses based on the characteristics information; and a transmitting unit for transmitting the data to be transmitted, to a network corresponding to the selected source address.

For example, the characteristics information is information relating to the connectability of each communication path to the destination. In this case, the communication path characteristics information acquiring unit confirms whether or not the communication path of each network is connected to the destination, and the source address selecting unit selects a source address corresponding to a network which is connected with the destination.

For example, the characteristics information is information relating to the delay of each communication path to the destination. In this case, the communication path characteristics information acquiring unit measures the delay of a communication path of each network, and the source address selecting unit selects a source address corresponding to a network of which the delay of the communication path is the minimum.

The communication apparatus of the present invention may further comprise a storage unit for storing correspondence of the selected source address and the destination. In this case, the communication path characteristics information acquiring unit acquires the characteristics information when the source address corresponding to the destination is not stored in the storage unit, and the source address selecting unit registers the source address selected based on the characteristics information into the storage unit correlating the selected source address with the destination. Preferably, the correspondence stored in the storage unit is deleted after a predetermined time period has passed.

According to the communication apparatus of the present invention, a communication apparatus that is assigned a plurality of source addresses can select a source address corresponding to a network having the optimal communication path among a plurality of networks and communicate using the selected source address.

### BRIEF DESCRIPTION OF THE DRAWINGS

FIG. 1 is an illustrative diagram of the conventional source address selection method;

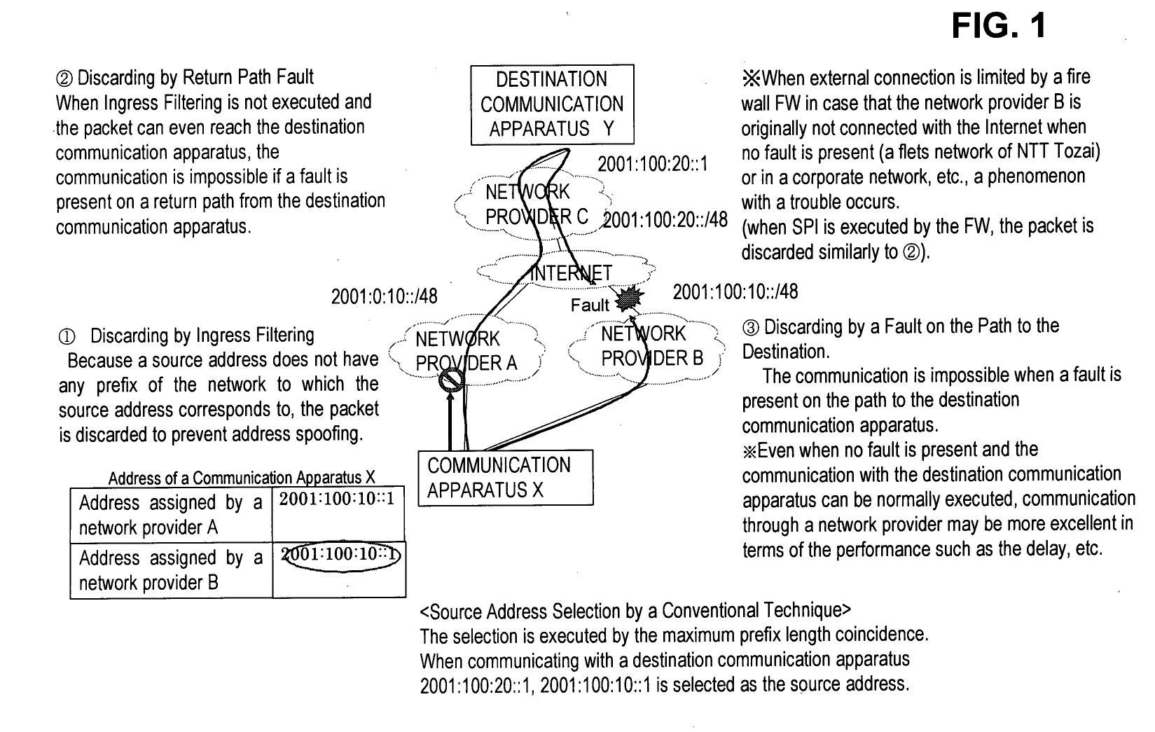

FIG. 2 shows an example of the composition of a communication apparatus according to a first embodiment of the invention;

FIG. 3 is a flowchart showing an example of a process of a transmission packet creating unit 12;

FIG. 4 is a flowchart of an example of a process of a source address selecting unit 15;

FIG. 5 is an illustrative diagram of an example of a process of the communication path characteristics information acquiring unit 17;

FIG. 6 is an illustrative diagram of a communication apparatus in a second embodiment of the invention;

FIG. 7 shows the block compositions of a terminal 1A and a gateway 1B in the second embodiment of the invention;

FIG. 8 shows another example of the block compositions of the terminal 1A and the gateway 1B in the second embodiment of the invention;

FIG. 9 shows an example of the block composition of the communication path characteristics information acquiring unit 17 for acquiring the characteristics information relating to the connectability of a network;

FIG. 10 is an illustrative diagram of an example of a process of the communication path characteristics information acquiring unit 17 for confirming the connectability utilizing an ICMP Echo message;

FIG. 11 shows an example of the block composition of the communication path characteristics information acquiring unit 17 for acquiring characteristics information relating to the delay on networks;

FIG. 12 is an illustrative diagram of an example of a process of the communication path characteristics information acquiring unit 17 for measuring the delay utilizing the ICMP Echo messages;

FIG. 13 shows an example of the block composition of the communication path characteristics information acquiring unit 17 for acquiring the characteristics information relating to the band of the communication path;

FIG. 14 shows an example of the block composition of the communication path characteristics information acquiring unit 17 for acquiring characteristics information relating to a policy of the communication path;

FIG. 15 shows an example of the composition of a policy storage unit 179;

FIG. 16 is an illustrative diagram of an example of a process for confirming the connectability utilizing name solving messages in the composition of FIG. 7;

FIG. 17 shows an example of a format of name solving messages;

FIG. 18 is an illustrative diagram of an example of another process for confirming the connectability using the name solving messages in the composition of FIG. 7;

FIG. 19 shows an example of a format of a Redirect message in IPv6;

FIG. 20 shows an example of a format of a Redirect message in IPv4

FIG. 21 shows an example of a process for the case where the gateway 1B receives communication packets from the terminal 1A in the composition of FIG. 8;

FIG. 22 is a flowchart of an example of a process for the gateway 1B to check the correspondence between a destination address and a source address of a communication packet;

FIG. 23 is an illustrative diagram of another example of the process for confirming the connectability utilizing the name solving messages in the composition of FIG. 7;

FIG. 24 shows an example of a format of a DHCP Static Route message; and

FIG. 25 shows another example of the block composition of the communication apparatus in the first embodiment of the invention.

### DESCRIPTION OF THE PREFERRED EMBODIMENTS

Embodiments of the present invention will now be described with reference to the accompanying drawings. It is however to be noted that the embodiments do not limit the technical scope of the present invention.

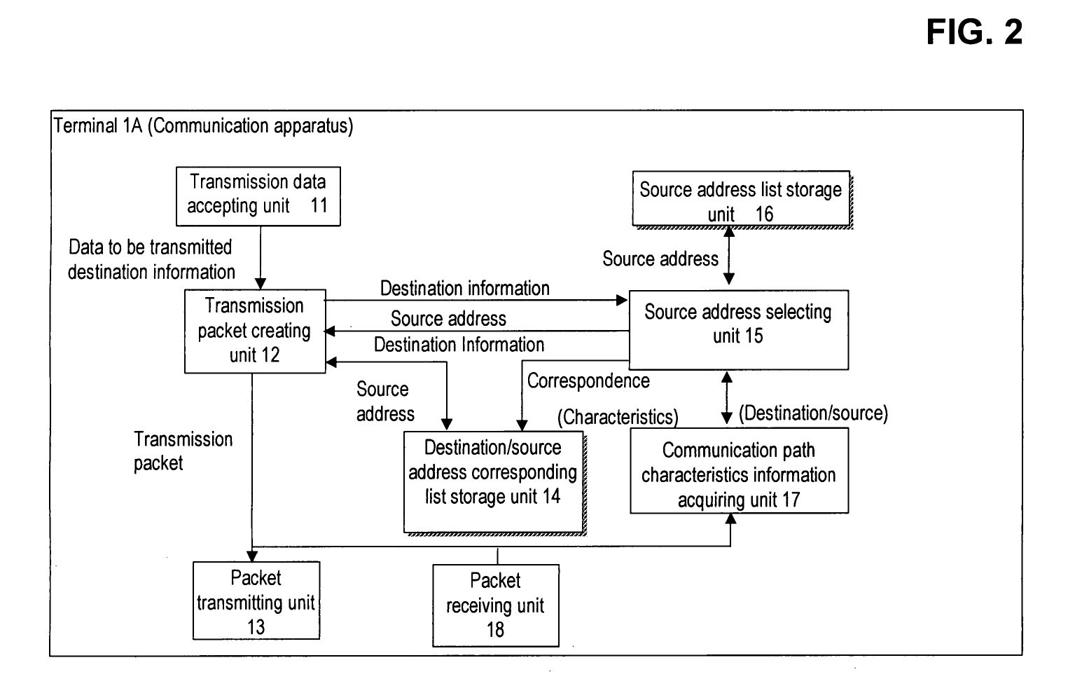

FIG. 2 is an illustrative diagram of a communication apparatus of a first embodiment of the present invention and shows an exemplary block composition of the first embodiment. The communication apparatus of the first exemplary composition is, for example, a terminal 1A such as a personal computer. The terminal 1A (communication apparatus) stores in a source address list storage unit 16 an IP address assigned from each network provider (hereinafter, simply referred to as “address”). The following three (3) methods can be mainly considered as methods of assigning addresses from a network provider (the present invention does not limit the assigning methods to the following methods).

IPCP (Internet Protocol Control Protocol)

DHCP (Dynamic Host Configuration Protocol)

RA (Router Advertisement)

Generally, an address comprises a network address section (called“prefix”)and a host address section. A network provider may provide an address including a prefix and a host address section, or may assign only a prefix and a communication apparatus having been assigned the prefix automatically creates a host address section from an MAC address, etc. and an address is composed. The source address list storage unit 16 stores the address acquired in this manner. In case that an address is assigned respectively from each of a plurality of network service providers, the source address storage unit 16 stores a plurality of addresses.

Having received, from an application, data to be transmitted, a transmission data accepting unit 11 sends the data and destination information to a transmission packet creating unit 12. Here, the destination information may be the address of a destination communication apparatus or the name of a host.

The transmission packet creating unit 12 processes the data into packets and creates transmission packets each attached with the source address and the destination address.

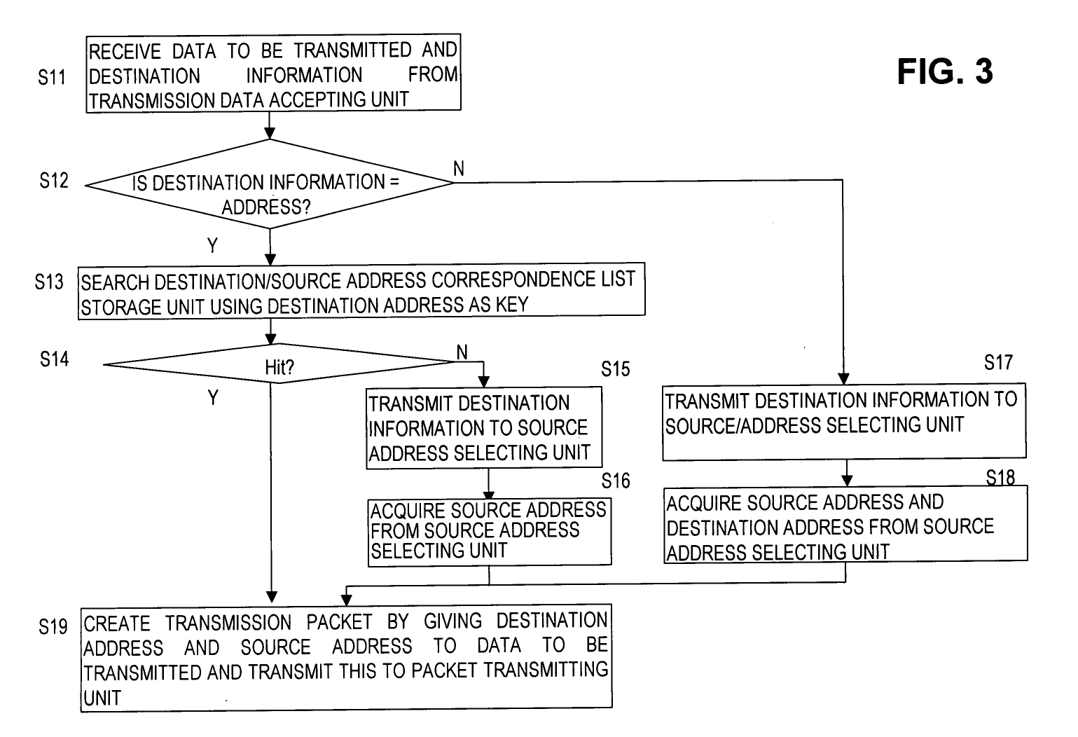

FIG. 3 is a flowchart showing an example of a process executed by the transmission packet creating unit 12. Having received the data to be transmitted and the destination information from the transmission data accepting unit 11 (S11), the transmission packet creating unit 12 determines whether or not the destination information is an address (S12). If the destination information is an address, an destination/source address correspondence list storage unit 14 is searched and whether or not a source address corresponding to the destination address is registered is inquired (S13). Then, if the source address is registered (S14), a transmission packet is created utilizing the address and is sent to a packet transmitting unit 13 (S19). If the source address can not be acquired (S14) or if the destination information is the name of the host (in this case, the source address also can not be acquired) (S12), the destination information is sent to a source address selecting unit 15 (Sl5 and S17). Then, by a process of the source address selecting unit 15 described later, when a response of the source address (S16) or the source address and the destination address (S18) are received, a transmission packet is created utilizing this address and is sent to the packet transmitting unit 13.

Referring back to FIG. 2, the destination/source address correspondence list storage unit 14 stores the correspondence of destination addresses and source addresses as well as deletes the registration of a correspondence when no inquiry is made for the correspondence for a predetermined time period.

The source address selecting unit 15 is an element characteristic to the present invention and selects a source address optimal for communication with a destination communication apparatus among a plurality of source addresses stored in the source address storage unit 16.

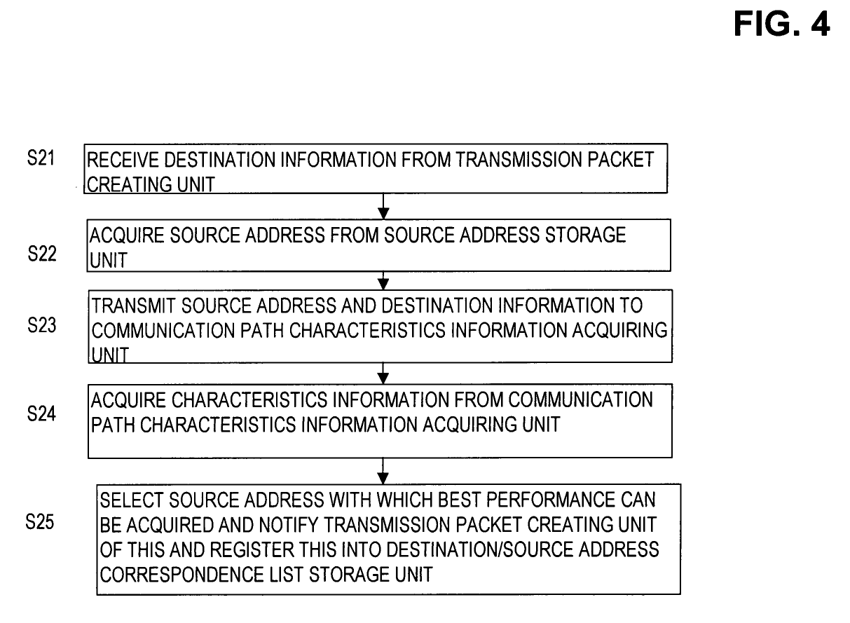

FIG. 4 is a flowchart of an example of a process of the source address selecting unit 15. Having received the destination information from the transmission packet creating unit 12 (S21), the source address selecting unit 15 acquires a plurality of source addresses stored in the source address list storage unit 16 (S22), sends the destination information and the source addresses to a communication path characteristics information acquiring unit 17 (S23) and waits for information from the communication path characteristics information acquiring unit 17. Then, the source address selecting unit 15 receives respectively characteristics information for the case where each of the source addresses is utilized from the communication path characteristics information acquiring unit 17 (S24), selects a source address for which the optimal performance can be acquired, based on the performance information, and sends the selected source address to the transmission packet creating unit 12 as a response as well as registers the selected source address into the destination/source address correspondence list storage unit 14 (S25).

When the destination information received from the transmission packet creating unit 12 is not a destination address but the name of a destination host, the communication path characteristics information acquiring unit 17 responds to the source address selecting unit 15 with the destination address together with the characteristics information. Then, the source address selecting unit 15 responds to the transmission packet creating unit 12 with the destination address together with the source address. In addition, the source address selecting unit 15 may regularly request the communication path characteristics information acquiring unit 17 to update the performance information and may reflect the result thereof on the destination/source address correspondence list storage unit 14.

The communication path characteristics information acquiring unit 17 acquires the characteristics information of a communication path between a communication apparatus and a communication apparatus to be communicated with. The characteristics information is information including connectability of the communication path (fault for communication, whether or not the path is not communicable), delay property when the path is communicable (communication speed), etc.

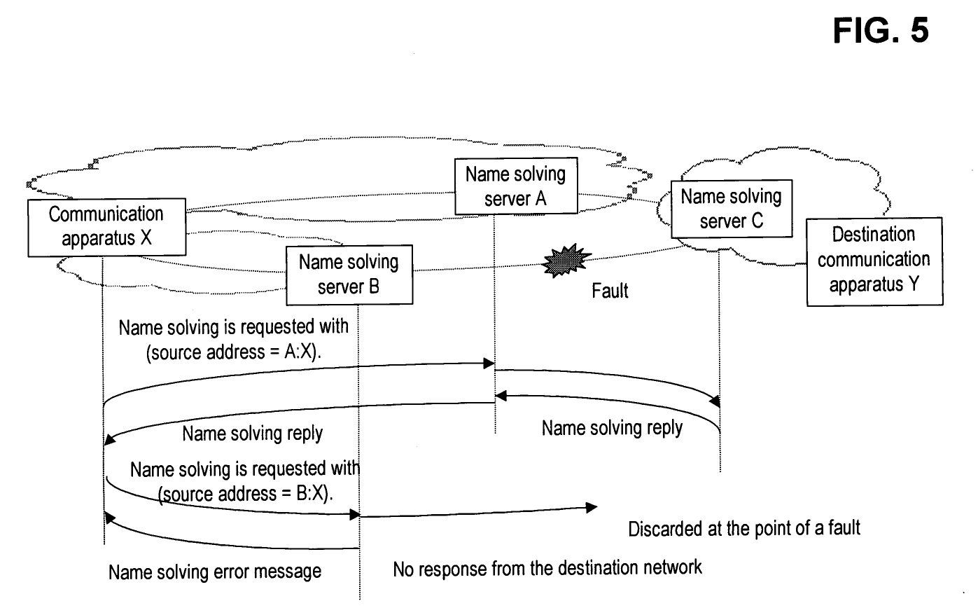

FIG. 5 is an illustrative diagram of an example of a process of the communication path characteristics information acquiring unit 17 in the first embodiment. The example of the process of FIG. 5 is a process for confirming the connectability between the communication apparatus X (a terminal 1A) and the destination communication apparatus Y and, is for acquiring characteristics information relating to the connectability utilizing the process for acquiring the destination address when the destination information is the name of the host. The communication path characteristics information acquiring unit 17 (the communication apparatus X) has acquired the plurality of source addresses from the source address storage unit 16. When the destination information is the name of the host, the communication path characteristics information acquiring unit 17 creates and sends to the packet transmitting unit 13 a name solving request message for which the address of each of name solving servers A and B of the network providers is the destination address and an address assigned by each of the network providers is used as the source address, in order to acquire the destination address. The packet transmitting unit 13 transmits the name solving request message to each of the name solving servers A and B. In the case of FIG. 5, the name solving server A receives a name solving response containing a destination address from a name solving server C to which the destination communication apparatus Y belongs, and the packet receiving unit 18 receives this response. On the other hand, because a fault is present on the communication path connecting with the name solving server C, the name solving server B does not receive the name solving response. In this case, the name solving server B transmits a name solving error message to the communication apparatus X.

The communication path characteristics information acquiring unit 17 receives the name solving response from the name solving server A, from the packet receiving unit 18 and acquires the destination address. Then, the communication path characteristics information acquiring unit 17 can acquire the destination address as well as can acquire information relating to the connectability with the destination communication apparatus of each network. That is, though a communication path routed through the name solving server A is connected with the network of the destination communication apparatus, a communication path routed through the name solving server B is not connected with the network of the destination communication apparatus.

Generally, the destination address acquired by the name solving response through each of the network providers is same. However, when server load distribution is applied, different addresses may be acquired. In this case, when each of the destination addresses is accessed, the address assigned by a network provider that has been passed through when the address is acquired is utilized as a source address.

As described above, the communication path characteristics information acquiring unit 17 can use the message for name-solving, in order to confirm the connectability with the network to which the destination communication apparatus belongs. That is, the network providers from which the name solving responses can not be acquired can be determined to have no connectability with the networks to which the destination communication apparatus belongs. On the other hand, the network providers from which the name solving responses can be acquired can be determined to have connectability with the networks to which the destination communication apparatus belongs. The communication path characteristics information acquiring unit 17 notifies the source address selecting unit 15 to the effect. A specific example of a method of acquiring the characteristics information will be further described later.

In this manner, based on the source address of a packet to be transmitted, the packet transmitting unit 13 transfers the packet to the network of the network provider that has assigned the source address.

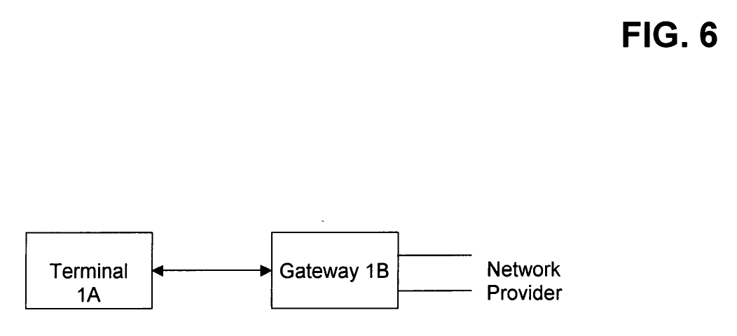

FIG. 6 is an illustrative diagram of a communication apparatus in a second embodiment of the present invention. The communication apparatus in the second embodiment is a gateway 1B connected with the terminal 1A. A plurality of terminals 1A can be connected with the gateway 1B and the plurality of terminals 1A can be connected with a network through the gateway 1B.

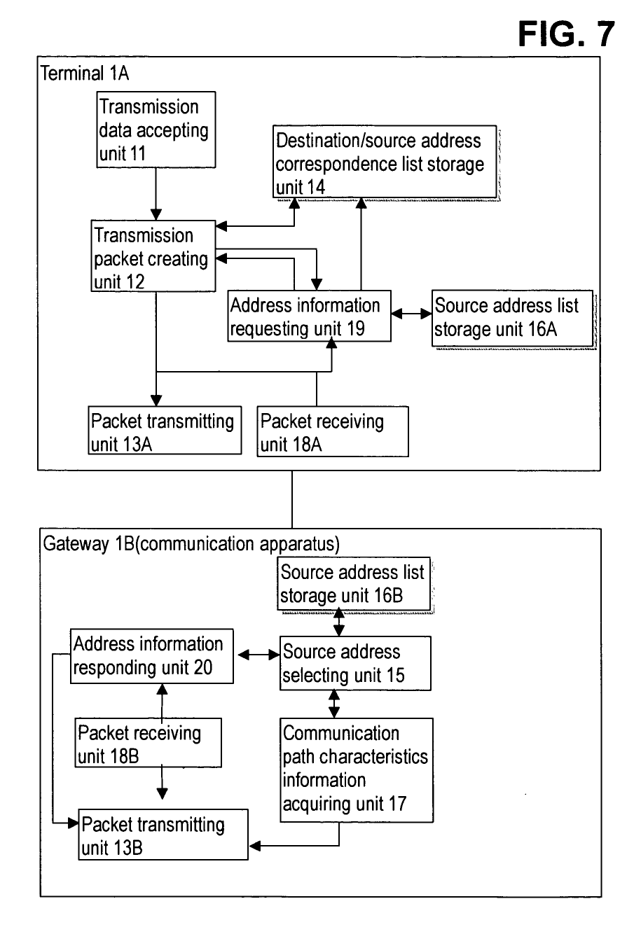

FIG. 7 shows the block compositions of the terminal 1A and the gateway (a communication apparatus) 1B in the second embodiment of the present invention. In the second embodiment, the source address selecting function in the terminal 1A of FIG. 2 is realized by the gateway 1B.

The gateway 1B is assigned a prefix by each of network providers respectively and stores this information in a source address list storage unit 16B as well as assigns addresses respectively using the prefix assigned by each of the network providers, to the terminal 1A. The terminal 1A stores in a source address list storage unit 16A the addresses assigned by the gateway 1B.

The terminal 1A comprises the transmission data accepting unit 11, the transmission packet creating unit 12, a packet transmitting unit 13A, the destination/source address correspondence list storage unit 14, a source address storage unit 17A, a packet receiving unit 18A and an address information requesting unit 19. The packet transmitting unit 13A transmits and the packet receiving unit 18A receives respectively packets to/from the gateway 1B.

The gateway 1B comprises packet transmitting means 13B, the source address selecting unit 15, a source address list storage unit 16B, the communication path characteristics information acquiring unit 17, packet receiving means 18B and address information responding means 20. The packet transmitting means 13B transmit and the packet receiving means 18B receive respectively packets to/from networks and the terminal 1A.

According to the composition of FIG. 2, the transmission packet creating unit 12 directly sends destination information to the source address selecting unit 15 and acquires directly an address from the source address selecting unit 15. However, according to the composition of FIG. 7, the destination information and the address are transmitted and received through the address information requesting unit 19 of the terminal 1A and the address information responding unit 20 of the gateway 1B. More specifically, the address information requesting unit 19 of the terminal 1A sends an address request containing the destination information to the address information responding unit 20 of the gateway 1B, and the address information responding unit 20 transfers the address request to the source address selecting unit 15. Then, the address information responding unit 20 notifies the address requesting unit 19 of the address selected by the source address selecting unit 15.

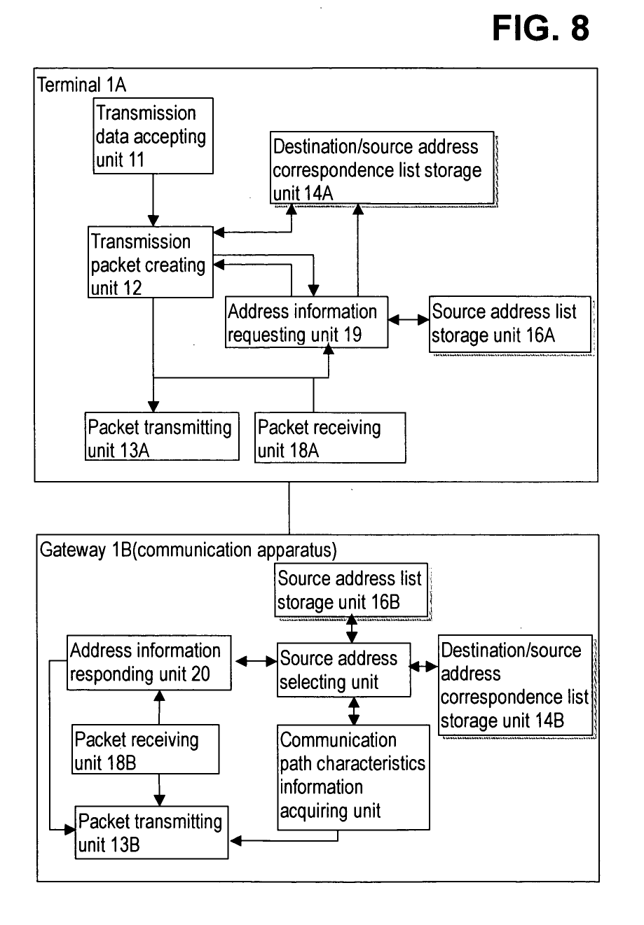

FIG. 8 shows another example of the block compositions of the terminal 1A and the gateway 1B in the second embodiment of the present invention. In FIG. 8, both of the terminal 1A and the gateway 1B respectively have destination/source address correspondence list storage units 14A and 14B. In case that a plurality of terminal 1A are connected with the gateway 1B, an address request respectively from each of the plurality of terminals 1A can be coped with by providing the destination/source address correspondence list storage unit 14B to the gateway 1B.

Now, various examples of acquiring the characteristics information in the communication path characteristics information acquiring unit 17 will be described.

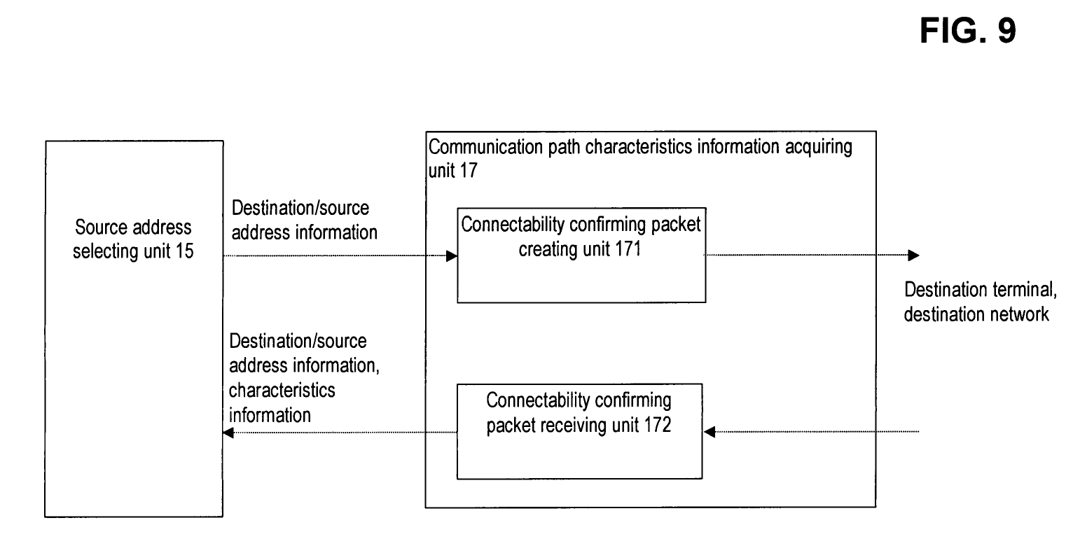

FIG. 9 shows an example of the block composition of the communication path characteristics information acquiring unit 17 for acquiring the characteristics information relating to the connectability of a network. The communication path characteristics information acquiring unit 17 comprises a connectability confirmation packet creating unit 171 and a connectability confirmation packet receiving unit 172. In case that a name solving message is utilized in order to confirm the connectability, the connectability confirmation packet creating unit 171 creates the name solving request described above (see FIG. 5) in response to an order from the source address selecting unit 15. The connectability confirmation packet receiving unit 172 receives the name solving response or the name solving error message and notifies the source address selecting unit 15 of that.

The confirmation of the connectability can be executed using, for example, ICMP Echo messages, SIP messages, session establishing messages of TCP, etc. may be utilized in addition to the name solving messages.

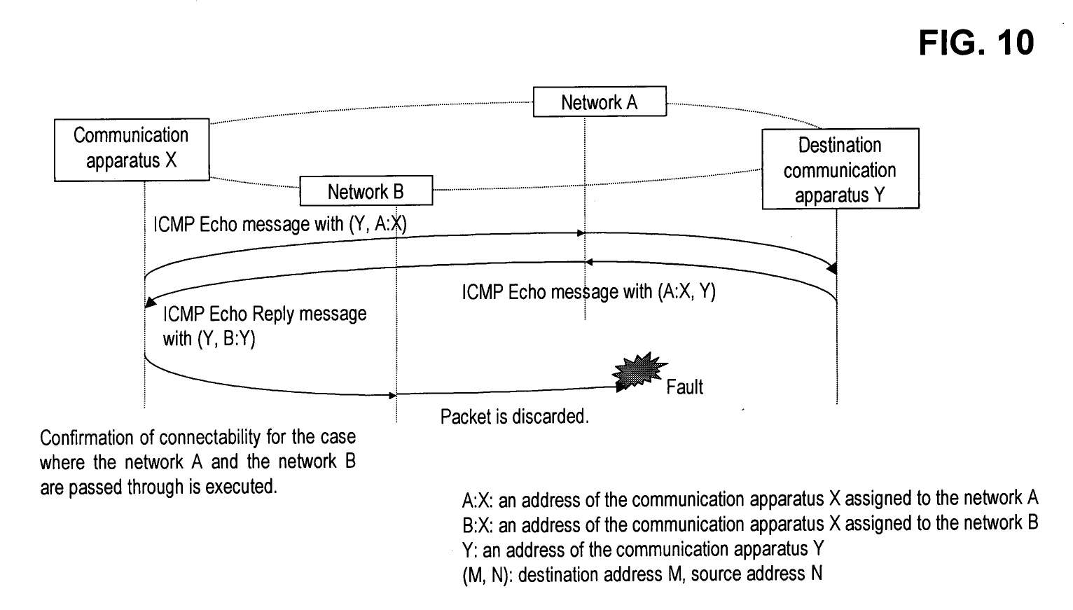

FIG. 10 is an illustrative diagram of an example of a process of the communication path characteristics information acquiring unit 17 for confirming the connectability utilizing the ICMP Echo message. When the ICMP Echo messages are utilized, the communication path characteristics information acquiring unit 17 (the connectability confirmation packet creating unit 171) of the communication apparatus X (the terminal 1A or the gateway 1B) creates an ICMP echo message for each of the source addresses respectively using the address of the destination communication apparatus Y as the destination address and the ICMP Echo messages are transferred to the destination communication apparatus Y through each network (when the name solving message is utilized, the name confirmation request is not transferred to the destination communication apparatus Y and a name solving server of the network before the destination communication apparatus Y, to which network the destination communication apparatus Y belongs executes a responding process). The destination communication apparatus Y returns ICMP Echo Reply messages corresponding to the ICMP Echo messages that have been normally received. Having received the ICMP Echo Reply messages, the communication path characteristics information acquiring unit 17 (the connectability confirmation packet receiving unit 172) of the communication apparatus X notifies the source address selecting unit 15 that the connectability for the source address of the ICMP Echo messages has been confirmed. On the other hand, when reception of the ICMP Echo Reply messages has been failed, the communication path characteristics information acquiring unit 17 notifies the source address selecting unit 15 that the connectability for the source address of the ICMP Echo messages has not been confirmed.

The connectability may be confirmed by transmitting a plurality of identical ICMP Echo messages. In this case, it is assumed that, for example, five (5) messages each of the ICMP Echo messages are transmitted. If five (5) messages of the ICMP Echo Reply messages to a source address can be received whereas only three (3) messages of the ICMP Echo Reply messages to another source address can be received, the source address selecting unit 15 may select to use the former source address. When the latter source address is used, it is estimated that two (2) messages of the five (5) messages have been discarded somewhere on the outgoing and incoming paths due to the congestion of the network.

When the SIP messages are utilized, the connectability confirmation packet creating unit 171 creates SIP Invite messages and transfers the SIP Invite messages to the destination communication apparatus or a mediating SIP proxy server. Having received the SIP Invite messages directly or through the SIP proxy server, the destination communication apparatus returns SIP 200 OK messages if no problem is present for the start of communication. Similarly to the case of ICMP Echo Reply, the connectability confirmation packet receiving unit 172 notifies the source address selecting unit 15 of the reception result of the SIP 200 OK massages and the source address selecting unit 15 selects a source address to use, based on the reception result.

The normality may be confirmed by a network management server (for example, the name solving server when the name solving messages are utilized), not as in case that responses are received from the destination communication apparatus to, for example, the ICMP Echo messages and the SIP messages, etc.

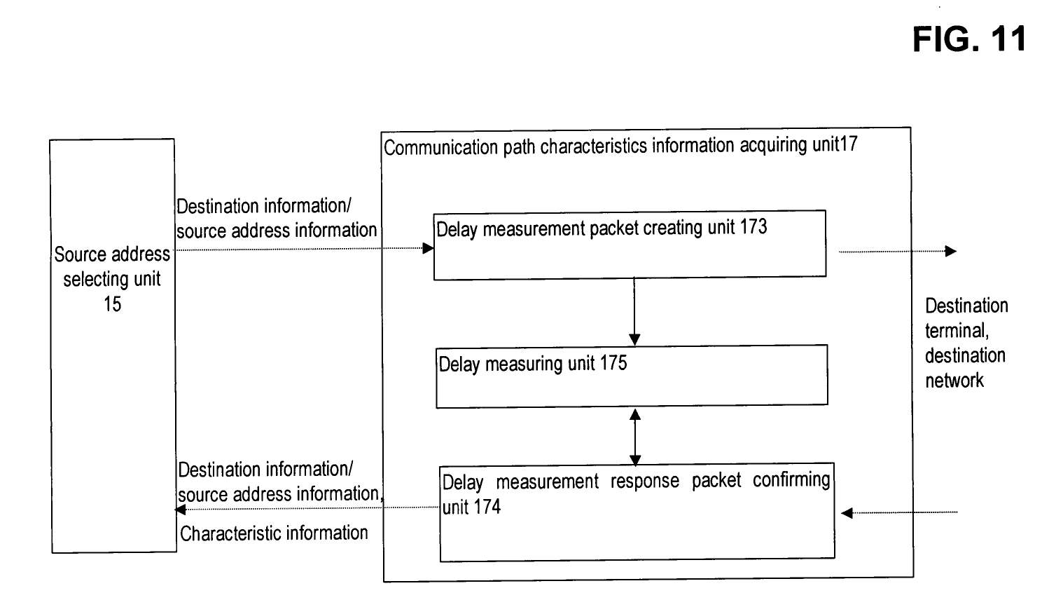

FIG. 11 shows an example of the block composition of the communication path characteristics information acquiring unit 17 for acquiring characteristics information relating to the delay on networks. The communication path characteristics information acquiring unit 17 comprises a delay measurement packet creating unit 173, a delay measurement response packet receiving unit 174 and a delay measuring unit 175. For the measurement of delay, the name solving messages, the ICMP Echo messages, the SIP messages, the session establishing messages of ICP, etc. are utilized.

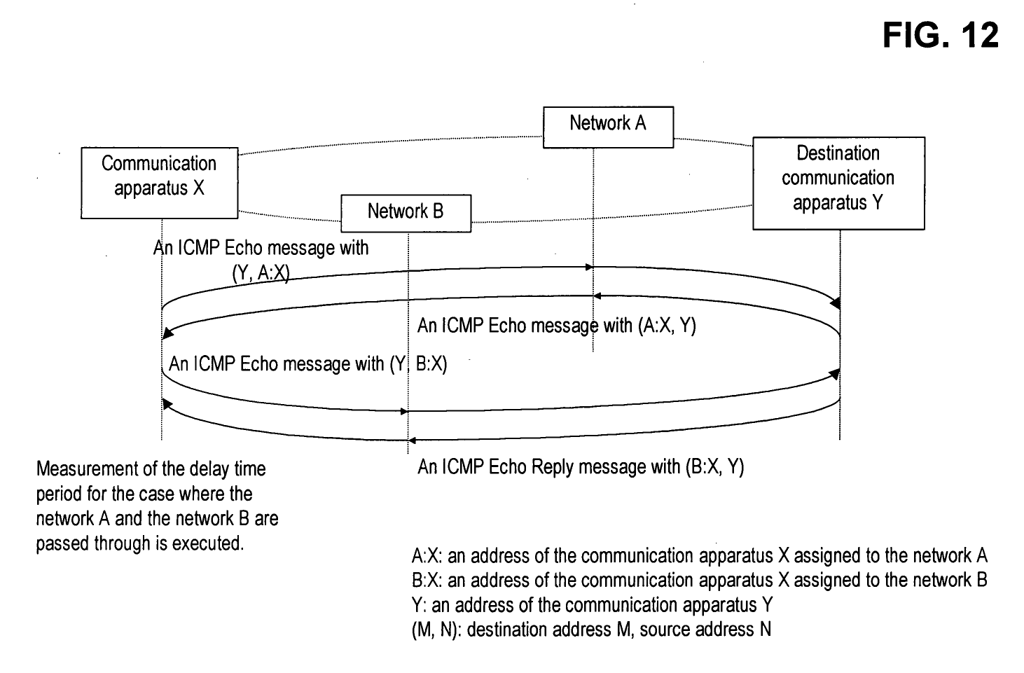

FIG. 12 is an illustrative diagram of an example of a process of the communication path characteristics information acquiring unit 17 for measuring the delay utilizing the ICMP Echo messages. The communication path characteristics information acquiring unit 17 (the delay measurement packet creating unit 173) of the communication apparatus X creates and transmits delay measurement packets utilizing ICMP Echo messages for each source address as the delay measurement packets as well as sets a timer of the delay measuring unit 175. Then, when the delay measurement response packet receiving unit 174 has received response packets (ICMP Echo Reply messages) corresponding to the delay measurement packets, the communication path characteristics information acquiring unit 17 notifies the source address selecting unit 15 of the value of the timer of the delay measuring unit 175 together with the source address. If no response has been retuned within a predetermined time period, the communication path characteristics information acquiring unit 17 notifies to this effect and of the source address. The source address selecting unit 15 selects a source address with which the shortest delay is realized. It is desirable that the measurement of the delay is executed not only once but also a plurality of times and the average value is notified to the source address selecting unit 15.

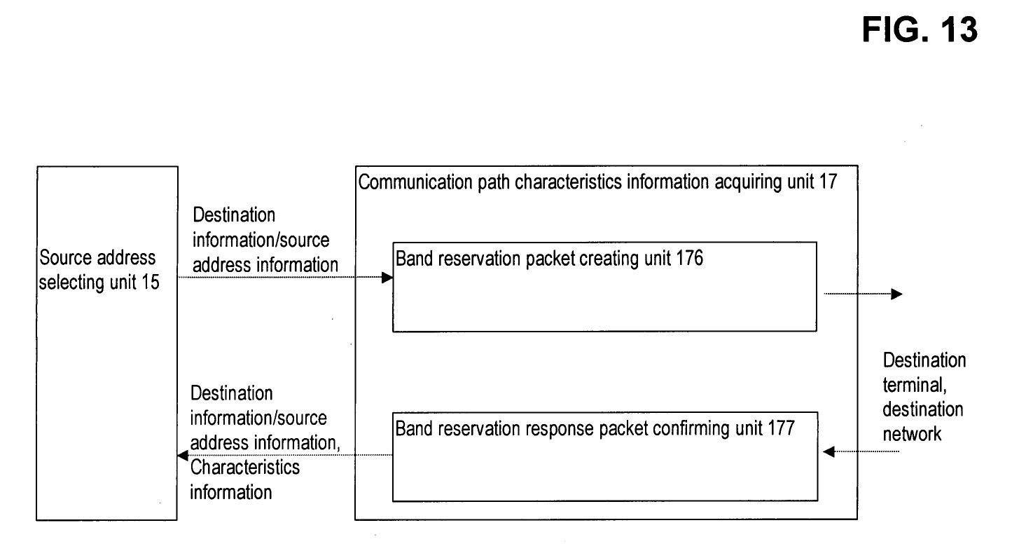

FIG. 13 shows an example of the block composition of the communication path characteristics information acquiring unit 17 for acquiring the characteristics information relating to the band of the communication path. The communication path characteristics information acquiring unit 17 comprises a band reservation packet creating unit 176 and a band reservation response packet receiving unit 177. As to band, a resource reservation protocol (RSVP) for the band reservation or messages such as the SIP messages, etc. are utilized. Messages to a network management server may be utilized.

The band reservation packet creating unit 176 creates and transmits a band reservation request packet to which the band that is desired to be used is described, for each source address utilizing a predetermined message. The band reservation response packet receiving unit 177 receives the band reservation response packet and notifies the source address selecting unit 15 of, together with the source addresses, information on bands that can be reserved, contained in the response packet. Then, the source address selecting unit 15 selects a source address with which a path having the widest band is realized.

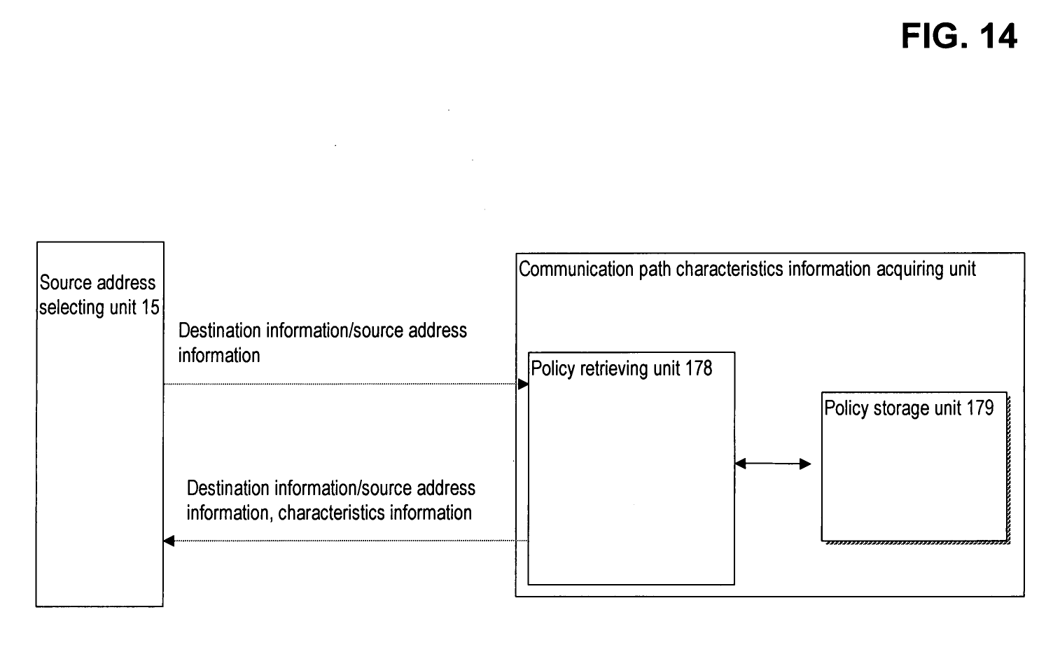

FIG. 14 shows an example of the block composition of the communication path characteristics information acquiring unit 17 for acquiring characteristics information relating to a policy of the communication path. The communication path characteristics information acquiring unit 17 comprises a policy retrieving unit 178 and a policy storage unit 179. A policy is the priority of networks to be utilized to connect with the destination address. The content of registration of the policy storage unit 179 can be constructed by settings made by network managers or downloading from management servers. In addition, when the priority can not be solved in the policy storage unit, the policy retrieving unit 179 may inquire of the network management server, etc. The priority to be set is at the discretion of a network manager and the present invention does not define the priority specifically. However, the priority may also be determined using communication cost as a criterion.

Having received the destination information, the policy retrieving unit 178 searches in the policy storage unit 179 using the destination information as the key and acquires the priority of a network to be connected. Then, the policy retrieving unit 178 notifies the source address selecting unit 15 of information of the priority. The source address selecting unit 15 selects an address assigned by a network having the highest priority in the acquired priority, as a source address. Preferably, the confirmation of the connectability described above may also be executed simultaneously and a network having the highest priority in the networks of which the connectability has been confirmed may also be selected.

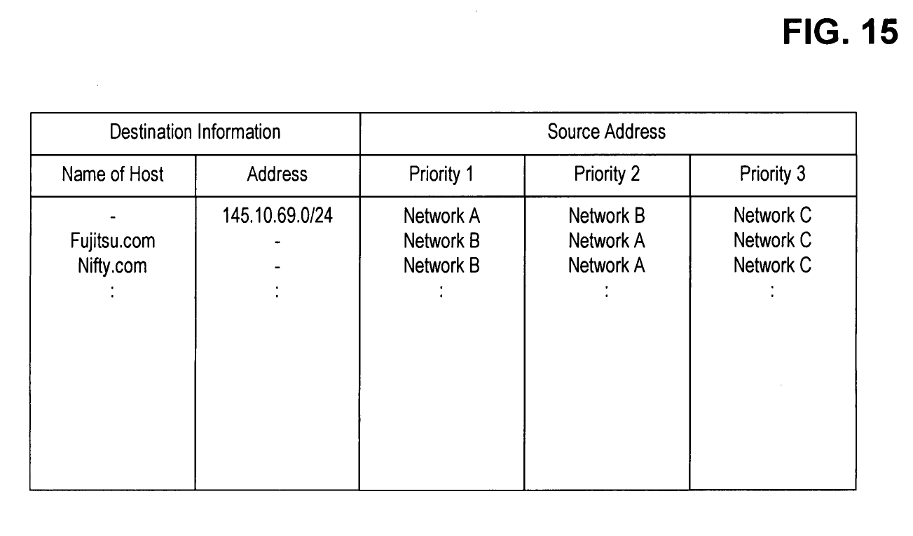

FIG. 15 shows an example of the composition of the policy storage unit 179. The destination information as the key for retrieving is, for example, a name of a host (a so-called FQDN: Fully Qualified Domain Name) or an address (a prefix), etc. Then, the policy storage unit 179 stores network identifiers at each priority level or prefixes assigned by the networks.

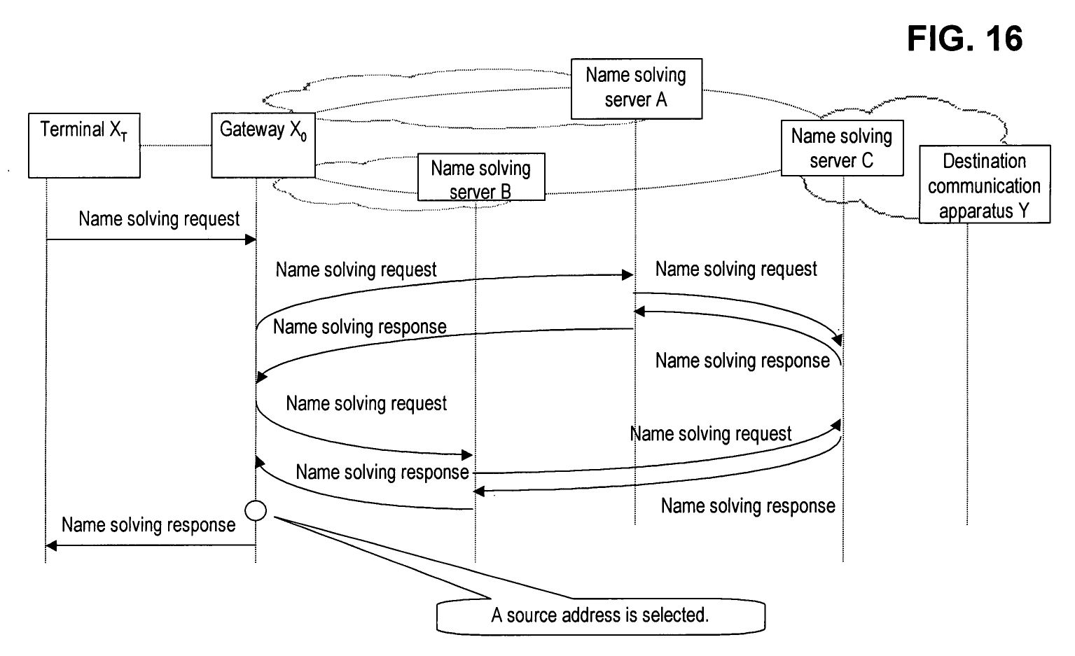

FIG. 16 is an illustrative diagram of an example of a process for confirming the connectability utilizing name solving messages in the composition of FIG. 7 (the second embodiment). In FIG. 16, first, when the terminal 1A (for example, the transmission packet creating unit 12) sends a name solving request to the gateway 1B, the communication path characteristics information acquiring unit 17 of the gateway 18 (the communication apparatus) sends the name solving request to a name solving server of each network and receives name solving responses. Then, the communication path characteristics information acquiring unit 17 notifies the terminal 1A of the source address selected by the source address selecting unit 15 and the source address selected utilizing the received name solving responses. Similarly to the above, in the example of the composition of FIG. 7, for the confirmation of the connectability, not only the name solving message but also other messages such as ICMP Echo message, etc. may be utilized.

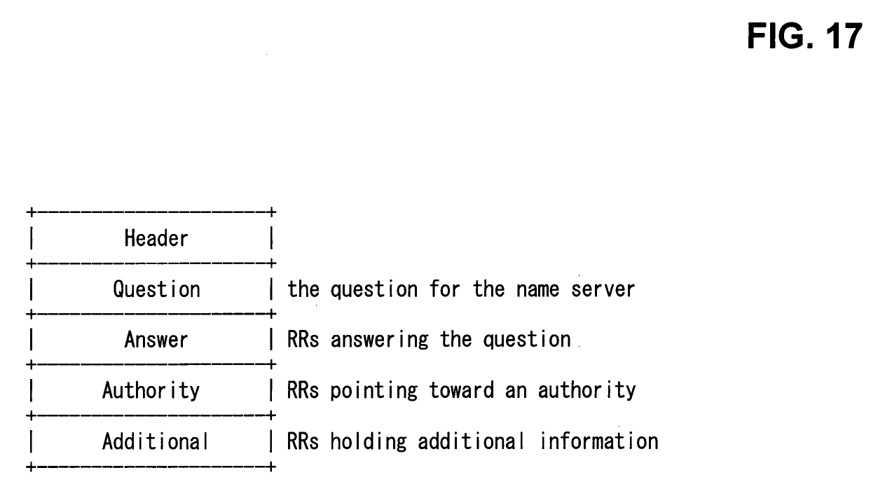

FIG. 17 shows an example of a format of a name solving message. In a name solving request message, the name of a host is contained in the cell for “Question” in the figure. On the other hand, in the name solving response message, address information of the host, the name of a name solving server and the address of the name of the name solving server are contained in the cells for “Answer”, “Authority” and “Additional”, respectively. When the gate way 1B transmits the name solving response message to the terminal 1A after the gateway 1B has selected a source address to be utilized, the name of the name solving server of a network provider that has assigned the source address and the address of the name solving server are contained in the cells for “Authority” and “Additional”, respectively. Having received the name solving response message, the terminal 1A determines to utilize the address that longest-prefix-matching with the address of the name solving server as the source address.

In the example described above, the information for selecting the source address to be utilized (the address of the name solving server) is notified to the terminal 1A using a field of the existing name solving message. However, a unique field may be defined and the source address (the prefix) may be notified using the field.

The source address to be utilized by the terminal 1A may be notified using an address given to the packet header for transferring the message but using the content of the message of the name solving server. That is, the address of the gateway 1B having a prefix identical with that of the selected source address is utilized as the source address of the name solving message to be transmitted from the gateway 1B to the terminal 1A. Having received this message, the terminal 1A determines to use the address longest-prefix-matching with the source address of this message as the source address.

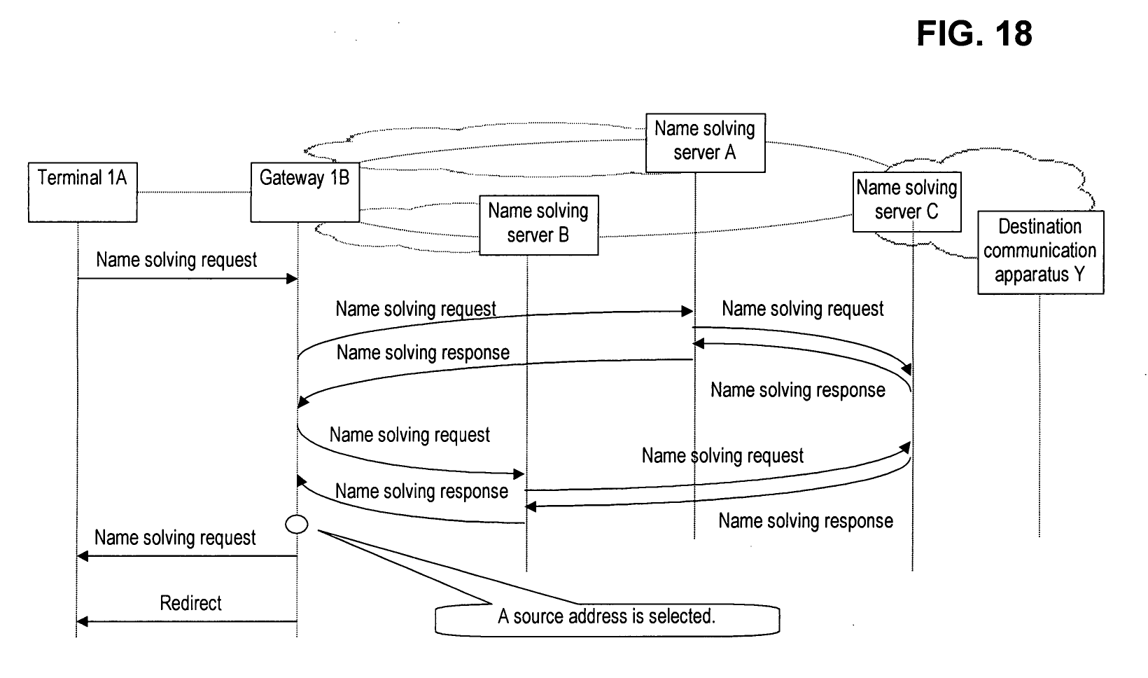

FIG. 18 is an illustrative diagram of an example of another process for confirming the connectability using the name solving message in the composition of FIG. 7. In FIG. 18, the source address from the gateway 1B (the communication apparatus) to the terminal 1A is not notified being contained in the name solving response and is notified utilizing a Redirect message that is different from the name solving response. Though the timing for transmitting the Redirect message is determined to be after that of the name solving response message in FIG. 18, the Redirect message may be transmitted after the gateway 1B has received communication packets from the terminal 1A to the destination communication apparatus.

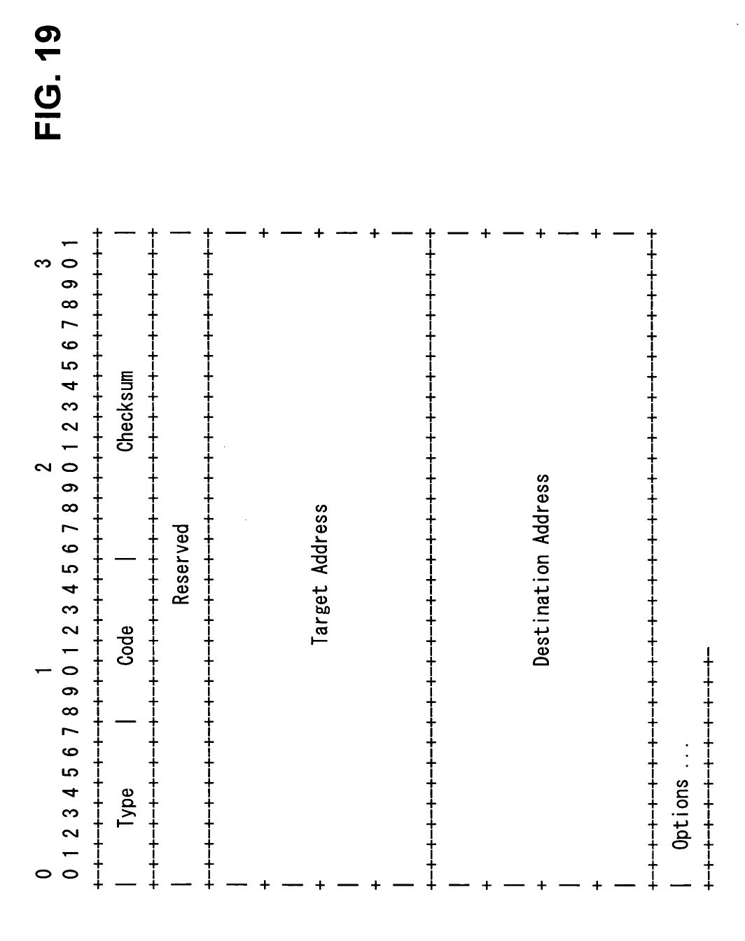

FIG. 19 shows an example of a format of a Redirect message in IPv6. The address of the gateway 1B using a prefix identical with that of the selected source address and the address of the destination communication apparatus are contained respectively in the cell for “Target Address” and the cell for “Destination Address” in the message.

The terminal 1A stores the correspondence with the destination address defining the address having a prefix identical with that of the source address of the gateway 10A contained in the Redirect message.

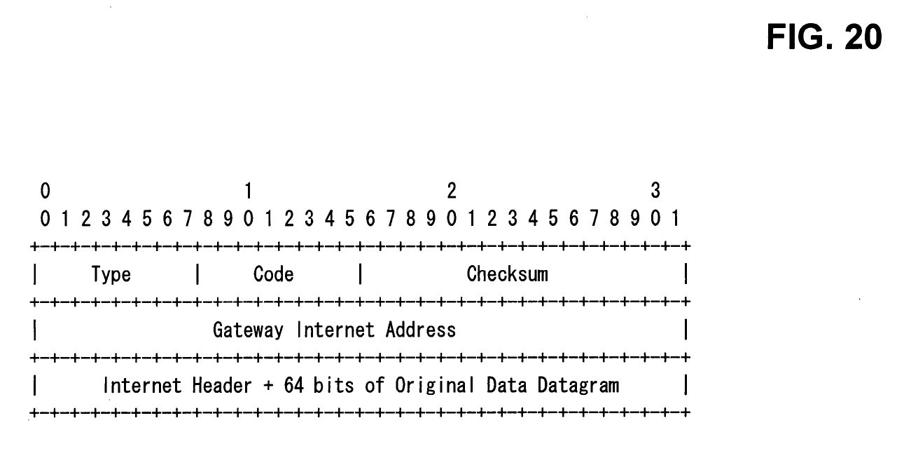

FIG. 20 shows an example of a format of a Redirect message in IPv4. the address of the gateway 1B using a prefix identical with that of the selected source address and the address of the destination communication apparatus are contained respectively in the cell for “Gateway Internet Address” and the cell for “Internet Header+65 bits of Original Data Datagram” in the message.

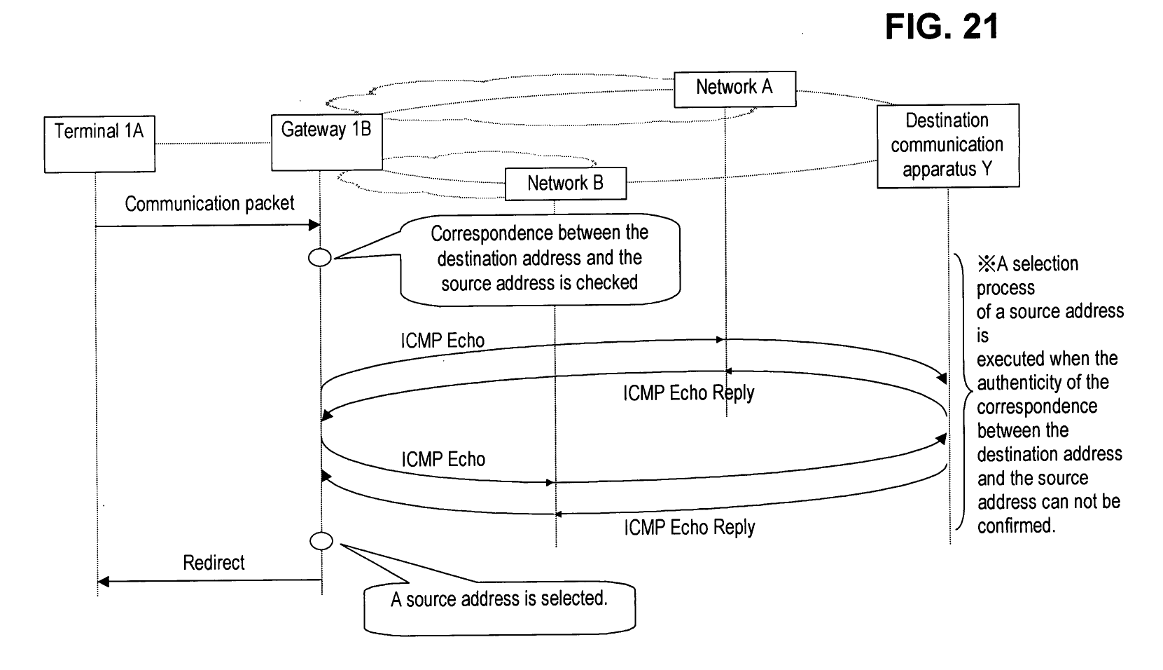

FIG. 21 shows an example of a process for the case where the gateway 1B receives communication packets from the terminal 1A in the example of the composition of FIG. 8. More specifically, an example is shown for the case where the gateway 1B (the communication apparatus) checks the correspondence between the destination address of the communication packets and the source address, selects another source address because the gateway 1B can not confirm the authenticity of the correspondence between the destination address of the communication packets and the source address, and notifies the terminal 1A of the appropriate source address using the Redirect message.

Though both of the terminal 1A and the gateway 1B respectively have the destination/source address correspondence list storage units 14A and 14B according to the composition of FIG. 8, cases may be present where the contents of the two (2) destination/source address correspondence list storage units 14A and 14B do not coincide. More specifically, each correspondence between a destination and a source address in a destination/source address correspondence list is selected by the source address selecting unit 15 and, after a predetermined time period has passed, is deleted. This is because the correspondence may have become non-optimal after a predetermined time period has passed for the characteristics of networks (the connectability, delay, band, etc.) are being changed real time. When, after deleting a destination address, a request for connecting with the same destination address is issued again, the characteristics information is acquired again and the optimal source address is selected. Then, the correspondence is stored in the source/address correspondence list storage unit 14. In this case, the time period for retaining the correspondence between the destination and the source address of the gateway 1B may be set at a time period shorter than that of the terminal 1A. This is because correspondence based on as new characteristics information as possible need to be set in order for the gateway 1B to select the final source address.

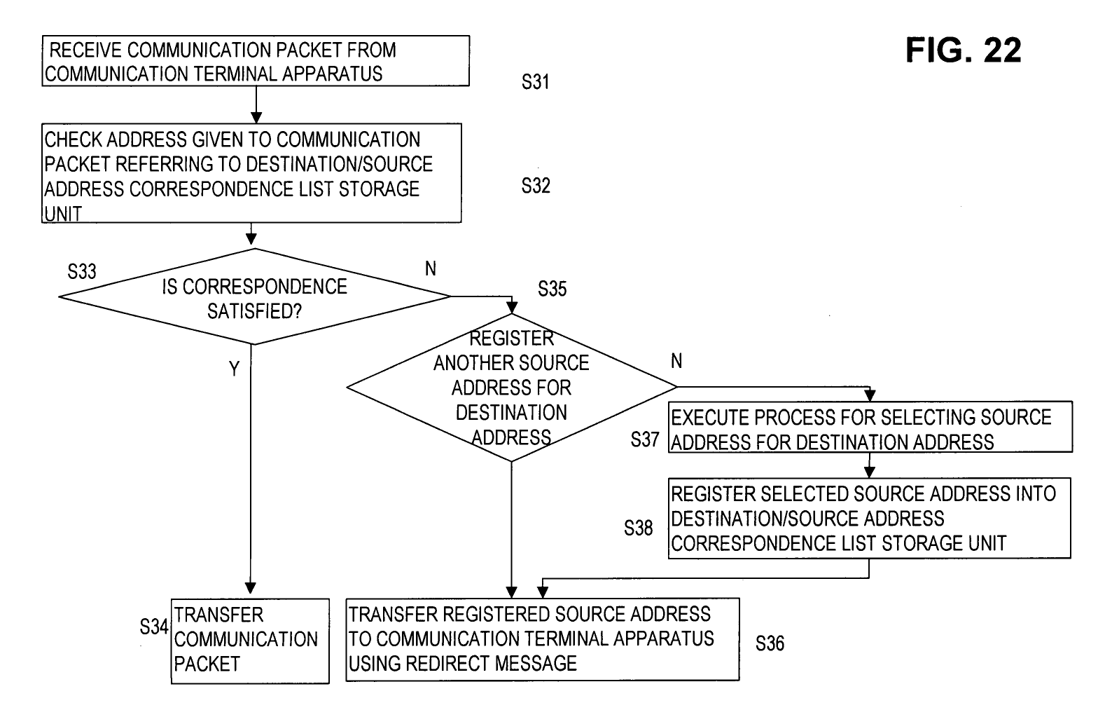

FIG. 22 is a flowchart of an example of a process for the gateway 1B to check the correspondence between a destination address and a source address of a communication packet. The terminal 1A transmits the communication packet to which a destination address and a source address are attached, to the gateway 1B based on the destination/source address correspondence list storage unit 14A of the terminal 1A itself. Having received the communication packet (S31), the gateway 1B checks the correspondence between the destination address and the source address of the received communication packet based on the destination/source address correspondence list storage unit 14B of the gateway 1B itself (S32). If the correspondence is satisfied at S33, the gateway 1B transmits the communication packet to a network (S34). If the correspondence is not satisfied and, furthermore, at a step S35, another correspondence is registered in the destination/source address correspondence list storage unit 14B of the gateway 1B, the source address in the other correspondence is notified to the terminal 1A using a Redirect message. The terminal 1A updates the destination/source address correspondence list storage unit 14A of the terminal 1A itself based on the source address.

If no correspondence is registered in the destination/source address correspondence list storage unit 14B of the gateway 1B at a step S35, the gateway 1B executes a source address selecting process using, for example, the ICMP Echo message as shown in FIG. 21 (S37), updates the destination/source address correspondence list storage unit 14B of the gateway 1B itself based on the selected source address (S38) as well as notifies the terminal 1A of the selected source address using the Redirect message (S36). Similarly, the terminal 1A updates the destination/source address correspondence list storage unit 14A of the terminal 1A itself based on the source address.

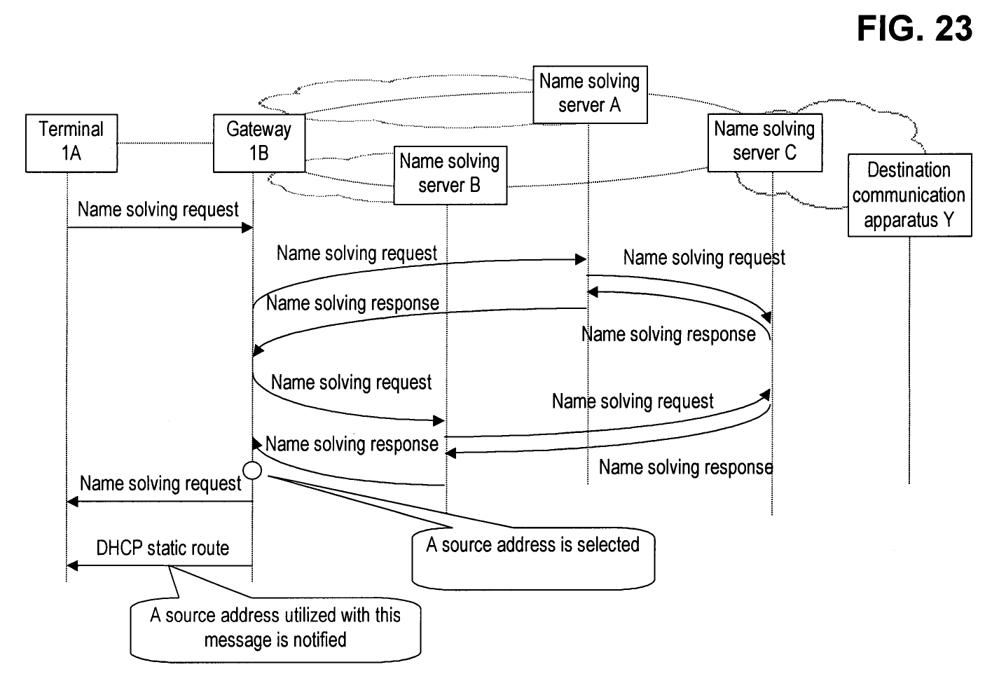

FIG. 23 is an illustrative diagram of another example of the process for confirming the connectability utilizing the name solving message in the composition of FIG. 7. Though the source address from the gateway 1B to the terminal 1A is notified utilizing the Redirect message in FIG. 18, the source address is notified utilizing a DHCP static route message in this example of the process.

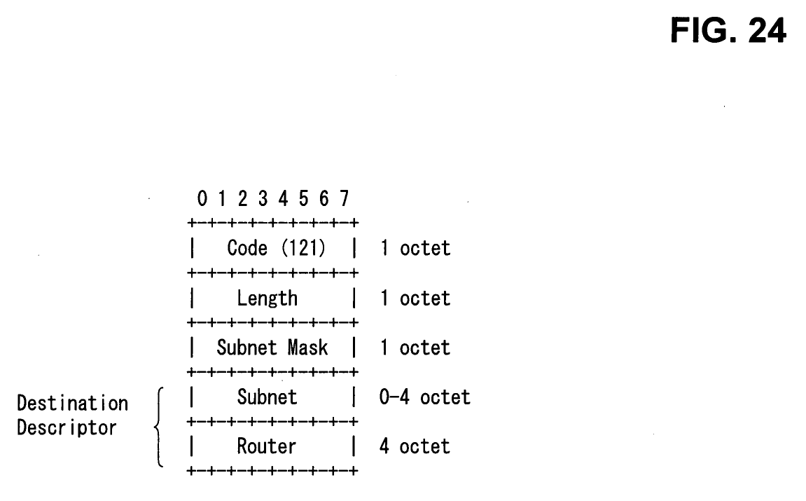

FIG. 24 shows an example of a format of the DHCP Static Route message. The gateway 1B stores respectively the address of the destination communication apparatus into a Destination Descriptor and the address of the gateway 1B that uses a prefix identical with that of the selected source address into a Router Address of the DHCP Static Route message and transmits the message to the terminal 1A. The terminal 1A stores the correspondence between the destination address and the source address that is an address having a prefix identical with that of the source address of the gateway contained in the DHCP Static Router message.

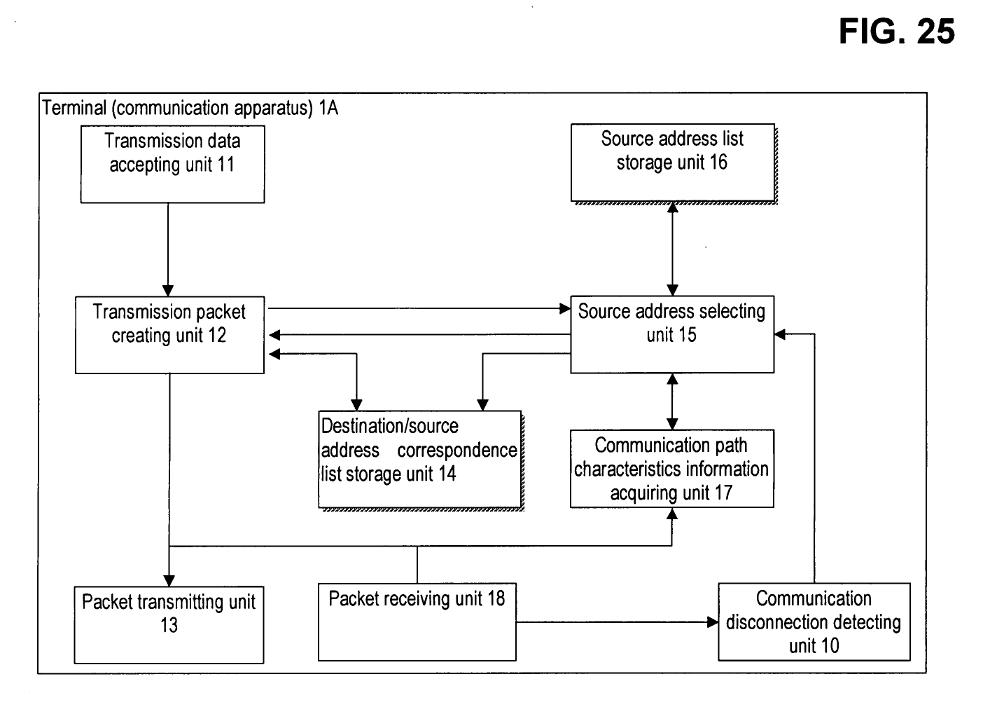

FIG. 25 shows another example of the block composition of the communication apparatus (the terminal) in the first embodiment of the present invention. In the example of the composition of FIG. 25, a communication disconnection detecting unit 10 is provided in addition to the composition of FIG. 2. When the communication disconnection detecting unit 10 has not received any communication packet from the destination communication terminal for a predetermined time period or has received an error message such as an ICMP Destination Unreachable message, etc., the communication disconnection detecting unit 10 determines that the connectability with the destination terminal is vitiated, and requests the source address selecting unit 15 to select another source address. The communication path characteristics information acquiring unit 17 acquires newly the characteristics information and the source address selecting unit 15 changes the source address to another source address based on the acquired characteristics information. The ICMP message of the IPv4 and the ICMPv6 message of the IPv6 are defined respectively in RFC792 and RFC2463.

In the embodiments described above, preferably, the source address selecting unit 15 may acquire regularly the characteristics information of communication paths that respectively pass through each of the network providers about the destination address of which the correspondence with the source address is stored in the destination/source address correspondence list storage unit 14, update the source address to a source address for which the characteristics are optimal, and register the correspondence between the new source address and the destination address into the destination/source address correspondence list storage unit 14.

In the above embodiments, the plurality of methods of selecting the source address have been shown. However, these methods are not limited to being used respectively alone and the source address may be selected by a combination of some of these methods.

Furthermore, the embodiments of the present invention can be applied to the case where a communication apparatus having different physical transmission media uses any one (1) of networks with which one (1) of the transmission media is connected, depending on the purpose. For example, a mobile telephone having a wireless LAN interface and supporting packet communication can be connected with the Internet, etc. through a wireless LAN or a mobile telephone network. In this situation, the present invention can be utilized in determining which of the wireless LAN interface and the packet communication function of the mobile telephone should be used to connect the telephone with the Internet, etc.

What is claimed is:

1. A communication apparatus that is connectable with a plurality of networks and is assigned with source addresses to connect with each respective one of the plurality of networks, comprising:
a communication path characteristics information acquiring unit for acquiring characteristics information of each communication path through each network to a destination, having received information relating to the destination of data to be transmitted;
a source address selecting unit for selecting one (1) source address among a plurality of source addresses based on the characteristics information; and
a transmitting unit for transmitting the data to be transmitted, to a network corresponding to the selected source address.

2. A communication apparatus according to claim 1, wherein
the characteristics information is information relating to the connectability of each communication path to the destination, wherein
the communication path characteristics information acquiring unit confirms whether or not the communication path of each network is connected to the destination, and wherein
the source address selecting unit selects a source address corresponding to a network which is connected with the destination.

3. A communication apparatus according to claim 1, wherein
the characteristics information is information relating to the delay of each communication path to the destination, wherein
the communication path characteristics information acquiring unit measures the delay of a communication path of each network, and wherein
the source address selecting unit selects a source address corresponding to a network of which the delay of the communication path is the minimum.

4. A communication apparatus according to claim 1, wherein
the characteristics information is information relating to the band of each communication path to the destination, wherein
the communication path characteristics information acquiring unit confirms an available band of a communication path of each network, and wherein
the source address selecting unit selects a source address corresponding to a network of which the available band is the widest.

5. A communication apparatus according to claim 1, wherein
the characteristics information is information relating to the priority of each communication path to the destination, wherein
the communication path characteristics information acquiring unit stores the priority of a source address to be selected for each destination, and wherein
the source address selecting unit selects a source address having the highest priority for the destination.

6. A communication apparatus according to claim 1, further comprising:
a storage unit for storing correspondence of the selected source address and the destination, wherein
the communication path characteristics information acquiring unit acquires the characteristics information when the source address corresponding to the destination is not stored in the storage unit, and wherein
the source address selecting unit registers the source address selected based on the characteristics information into the storage unit correlating the selected source address with the destination.

7. A communication apparatus according to claim 6, wherein
the correspondence stored in the storage unit is deleted after a predetermined time period has passed.

8. A communication apparatus according to claim 1, wherein the communication apparatus is connected with a terminal and transmits data to be transmitted sent from the terminal, to a network, wherein
the communication path characteristics information acquiring unit acquires the characteristics information in response to a request from the terminal, and wherein
the source address selecting unit notifies the terminal of a source address selected based on the characteristics information.

9. A communication apparatus according to claim 1, further comprising:
a detecting unit for detecting communication disconnection of a communication path to the destination based on the selected source address, wherein
the communication path characteristics information acquiring unit again acquires the characteristics information when the detecting unit detects the communication disconnection, and wherein
the source address selecting unit changes a source address to be selected based on the characteristics information.

10. A communication apparatus according to claim 1, wherein
the communication path characteristics information acquiring unit regularly acquires the characteristics information, and wherein
the source address selecting unit regularly updates a source address to be selected based on the characteristics information.
